(19) United States
(12) Patent Application Publication
(10) Pub. No.: US 2006/0095319 A1
(43) Pub. Date: May 4, 2006

(54) Marketing and compensation method

(76) Inventor: Carlzo Bernard Cardwell, Richfield, OH (US)

Correspondence Address: CURATOLO SIDOTI CO., LPA, 24500 CENTER RIDGE ROAD, SUITE 280, CLEVELAND, OH, 44145, US

(21) Appl. No.: 10/977,413

(22) Filed: Oct. 29, 2004

(51) Int. Cl. G06Q 30/00

(52) U.S. Cl. 705/14

(57) ABSTRACT

The invention relates to a marketing and compensation method and computer system that can be utilized in connection with the marketing and sale of products and/or services. The method and computer system may be utilized in connection with the marketing and sale of products and/or services relating to the collection and storage of biological samples.

The present invention relates to a marketing and compensation method. The present invention more particularly relates to a marketing and compensation method, a computer software program, and a computer system, which can be utilized in connection with the marketing and sale of products and/or services. The method, software program, and computer system may be utilized in connection with the marketing and sale of biological sample collection and preservation services.

### BACKGROUND

Multi-level marketing, also known as network marketing or matrix marketing, refers to a marketing method in which compensation in the form of a monetary commission is provided not only to the marketing network participant that is responsible for making sales of products and/or services, but also for sales of products and/or services made by other network participants they recruit into the marketing network, and by those network participants recruited into the marketing network by their recruits.

According to published reports, many multi-level marketing models place significant emphasis on recruiting additional participants into the marketing network, rather than actually focusing on the marketing and selling products and/or services of the business. However, placing greater emphasis on recruiting participants into the network rather than focusing on marketing and selling products and services often leads to the demise of the business. Thus, there is a need in the industry for an improved marketing method and system for carrying out the method that emphasizes the development, marketing, and sale of the products and/or services of the business.

Stem cells are primitive cells that are capable of proliferating or regenerating indefinitely and differentiating into multiple cell and tissue types. Human stem cells can be harvested from any known source of stem cells, including, for example, adult bone marrow, peripheral mobilized blood, umbilical cord blood, embryonic yolk sac, fetal bone marrow, fetal liver, and fetal spleen. It is widely known that the umbilical cord blood provides an abundant source of stem cells. Additionally, stem cells harvested from the umbilical cord blood of a live birth are an identical genetic match for the baby. Thus, there is no potential risk of graft versus host disease in these stem cell transplants.

Stem cells have potential in treating a wide variety of diseases, including cancers such as leukemia, blood disorders, immune disorders such as lupus, and genetic disorders such as sickle cell anemia. In fact, it is estimated that over 2000 stem cell transplants have been performed worldwide. Transplant Advisory. Cord Blood News, Volume 3, No. 1, 1998. Current stem cell research indicates that stem cells may also be effective in the treatment of stroke, spinal cord injuries, Parkinson's disease, Alzheimer's disease, cardiovascular disorders, and HIV/AIDS.

There are approximately four million (4,000,000) live births in the United States on an annual basis. National Vital Statistics Reports, Volume 51, Number 2, Dec. 18, 2002. There are approximately 35,000 to 40,000 birthing professionals, including licensed obstetricians/gynecologists, midwives, and the like, in the United States that service the maternity patients and their births.

There are approximately 25 companies in the United States that are in the business of umbilical cord blood stem cell storage. The process of collecting and storing stem cells is often referred to as stem cell “banking.” A maternity patient that is interested in collecting and preserving/storing umbilical cord blood stem cells is required to enter into a contract with a cord blood stem cell banking company. Such contracts generally provide that the maternity patient will pay the stem cell banking company in advance for all required testing, physician fees for collecting the umbilical cord blood stem cells, processing and transportation fees for the umbilical cord blood stem cells, and the initial year stem cell storage fee (the “banking fee”).

For most maternity patients, the birthing professional is the first and primary contact throughout pregnancy and the actual birthing process. Nevertheless, many umbilical cord blood stem cell banking companies continue to market their products and services directly to the maternity patient through print advertising or over the internet. Assuming that a maternity patient is interest in collecting and banking umbilical cord blood stem cells, a contract is signed, the fee is paid, and the collection kit is mailed directly to the maternity patient. The maternity patient must take the collection kit to the hospital and advise the birthing professional that umbilical cord blood stem cells are to be collected from the live birth. In some instances, the presentation of the collection kit to the physician at the time of the birth may be the first time that the physician actually learns that the maternity patient desires stem cell collection and banking.

Furthermore, the maternity patient may not understand the detailed procedures or potential benefits of collecting and storing umbilical cord stem cells. The current marketing methods of the banking companies may not adequately provide a maternity patient contemplating stem cell collection and banking with the necessary information to enable the patient to make an informed decision regarding stem cell banking.

### SUMMARY

A method of compensating participants within a marketing network is provided, said method comprising rewarding a monetary credit to said participant based upon the occurrence of at least one event; and forwarding a monetary payment to a third party payee on behalf of said participant in at least partial payment of a debt of said participant, wherein said monetary payment comprises a portion of said monetary credit rewarded to said participant.

According to another embodiment, said method of compensating participants within a marketing network comprises selecting a participant within said marketing network; identifying the occurrence of at least one event which results in the reward of a monetary credit to said participant; associating the occurrence of said at least one said event with said participant; rewarding a monetary credit to said participant based upon the occurrence of said at least one event; and forwarding a monetary payment to a third party payee on behalf of said participant in at least partial payment of a debt of said participant, wherein said monetary payment comprises a portion of said monetary credit rewarded to said participant.

According to another embodiment, said method of compensating participants within a marketing network comprises using a computer, wherein said method comprises inputting into a computer information relating to a participant within said marketing network and the occurrence of at least one event that gives rise to the reward of a monetary credit to said participant; processing said information thereby associating the occurrence of said at least one event with said participant and rewarding a monetary credit to said participant; and forwarding a monetary payment to a third party payee on behalf of said participant in at least partial payment of a debt of said participant, wherein said monetary payment comprises a portion of said monetary credit rewarded to said participant.

According to a further embodiment, said method of compensating participants within a marketing network comprises using a computer, wherein said method comprises inputting into said computer information relating to a participant within said marketing network and the occurrence of at least event that gives rise to the reward of a monetary credit to said participant, said computer comprising input receiving means, a processor, computer storage memory, and executable computer software stored on said memory; said computer software associating the occurrence of at least one said event with said participant; said computer software calculating a monetary credit to be rewarded to said participant based upon the occurrence of said at least one event associated with said participant; said computer software rewarding said monetary credit to said participant; storing said rewarded monetary credit to said participant in said computer storage memory; said computer software calculating an amount based on at least a portion of said monetary credit rewarded to said participant; and forwarding said amount to a third party payee on behalf of said participant in at least partial payment of a debt of said participant.

According to a further embodiment, the method of compensating a participant within a marketing network and paying a third party payee comprises providing a computer in communication with a computer network, said computer comprising input receiving means, a processor, computer storage memory, and executable computer software stored on said computer storage memory; inputting into said computer information relating to a participant within said marketing network and the occurrence of at least event that gives rise to the reward of a monetary credit to said participant; said computer software associating the occurrence of at least one said event with said participant; said computer software calculating a monetary credit to be rewarded to said participant based upon the occurrence of said at least one event associated with said participant; said computer software rewarding said monetary credit to said participant; storing said rewarded monetary credit to said participant in said computer storage memory; said computer software calculating an amount based on at least a portion of said monetary credit rewarded to said participant; and forwarding via said computer network an electronic payment in said calculated amount to a third party payee on behalf of said participant in at least partial payment of a debt of said participant.

A computer program product for use with a computer is provided, said computer program comprising a computer readable storage medium having computer readable program code embodied in said medium, said computer readable program code comprising computer readable code for creating a database of marketing network participants; computer readable code for associating the occurrence of at least one event with a marketing network participant selected from said created database; computer readable code for rewarding a monetary credit to said selected marketing network participant based on said at least one event associated with said marketing network participant; and computer readable code for calculating an amount based on at least a portion of said monetary credit rewarded to said participant, wherein said calculated amount is to paid to a third party payee on behalf of said participant in at least partial payment of a debt of said participant.

According to another embodiment, a method of using a computer in connection with the method of compensating a participant within a marketing network and paying a third party payee is provided, said method comprising providing a computer, said computer comprising input receiving means, a processor, computer readable storage medium having computer readable program code embodied in said medium, said computer readable program code comprising computer readable code for creating a database of marketing network participants; computer readable code for associating the occurrence of at least one event with a marketing network participant selected from said created database; computer readable code for rewarding a monetary credit to said selected marketing network participant based on said at least one event associated with said marketing network participant; computer readable code for calculating an amount to be paid to a third party payee on behalf of said participant in at least partial payment of a debt of said participant; inputting into said computer information relating to a participant within said marketing network and the occurrence of at least event that results in the reward of a monetary credit to said participant; associating the occurrence of at least one event with a marketing network participant selected from said created database; rewarding a monetary credit to said selected marketing network participant based on said at least one event associated with said marketing network participant; and calculating an amount based on at least a portion of said monetary credit rewarded to said participant; and forwarding said calculated amount to a third party payee on behalf of said participant in at least partial payment of a debt of said participant.

A computer system for use in connection with a method of compensating participants within a network is provided, said computer system comprising input receiving means, a processor, computer readable storage medium having computer readable program code embodied in said medium, said computer readable program code comprising computer readable code for creating a database of marketing network participants; computer readable code for associating the occurrence of at least one event with a marketing network participant selected from said created database; computer readable code for rewarding a monetary credit to be rewarded to said selected marketing network participant based on said at least one event associated with said marketing network participant; and computer readable code for calculating an amount based on at least a portion of said monetary credit rewarded to said participant, wherein said calculated amount is to paid to a third party payee on behalf of said participant in at least partial payment of a debt of said participant.

A method of compensating a purchaser of a biological sample collection and storage program requiring future periodic payments to maintain the program in force is provided, the method comprising providing to said purchaser, at the time of the purchase of said program, a voucher that is redeemable at a future time for a monetary sum; and after said voucher is redeemed, applying said monetary sum to at least one future periodic program payment.

A method of compensating a third party designee of a purchaser of a biological sample collection and storage program is provided, the method comprising providing to said purchaser, at the time of the purchase of said program, with a voucher that is redeemable at a future time for a monetary sum by a third party designee of said purchaser.

### BRIEF DESCRIPTION OF THE DRAWINGS

FIG. 1 is a flow chart showing one embodiment of the invention.

FIG. 2 is a flow chart showing another embodiment of the invention.

FIG. 3 is a flow chart showing an embodiment of using a computer in the method of the invention.

FIG. 4 is a flow chart showing another embodiment of using a computer in the method of the invention.

FIG. 5 shows one embodiment of the computer system of the invention.

### DETAILED DESCRIPTION

A method of compensating persons, including without limitation, participants within a marketing network, or other entities or organizations is provided. The method of compensation includes rewarding a monetary credit to a participant based upon the occurrence of an event or events, and forwarding a monetary payment to a third party payee on behalf of the participant in at least partial payment of a debt of the identified participant. The monetary payment that is made to the third party payee includes at least a portion of the monetary credit that is earned by and, in turn, rewarded to the marketing network participant.

According to certain embodiments, the method of compensating participants within a marketing network includes first selecting a participant within the marketing network and identifying an event or events that give rise or otherwise entitle the marketing network participant to a reward of a monetary credit. Once the network participant has been selected and the event or events giving rise to the monetary credit have been identified, then upon the occurrence of the identified event or event, the event or events are associated with the marketing network participant. A monetary credit is rewarded to the network participant, where the monetary credit reward is based upon the occurrence of the event or events that have been associated with the network participant. A monetary payment is generated and forwarded to a third party payee on behalf of the network participant in at least partial payment of a debt of the participant. The monetary payment includes a portion of the monetary credit that has been rewarded to the participant based on the cumulative number of events that have occured which give rise to a monetary credit attributable to the participant. After the designated debt of the participant to the third party has been paid in full, then the participant is entitled to receive payment in the form of cash.

According further embodiments, the method of compensating participants within a marketing network involves the use of a computer system having a computer readable medium included therein. The method includes inputting information specific to a participant within the marketing network into the memory of the computer. The event or events that give rise to the reward of a monetary credit to the participant are identified and the occurrence of such event or events are also inputted into the memory of the computer. The occurrence of the event or events are associated with the network participant, and a monetary credit is rewarded to the participant, based on the association of the event or events with the network participant. An amount of a monetary payment is calculated, based on the cumulative monetary credits that have been rewarded to the participant, which have been rewarded based on the number of events that have occurred and that have been associated with the network participant. Once the monetary payment has been calculated, it is forwarded to a third party payee on behalf of the participant in at least partial payment of a debt of the participant. Again after the designated debt of the participant to the third party has been paid in full, then the participant is entitled to receive payment in the form of cash.

The computer system used in connection with the method for compensating participants includes input receiving means, a processor, computer storage memory, and executable computer software stored on the computer storage memory. The computer software stored on the computer storage memory is capable of carrying out a number of tasks, including without limitation, associating the occurrence of at least one said event with said participant, calculating a monetary credit to be rewarded to a participant based upon the occurrence of an event or events that are associated with a participant, rewarding the calculated monetary credit to a participant, and calculating an amount of a payment to be paid to a third party payee of a participant, which is based on at least a portion of the calculated monetary credit or credits that are rewarded to a participant.

According to a further embodiment, the method of compensating participants within a marketing network comprises providing a computer in communication with a computer network, said computer comprising input receiving means, a processor, computer storage memory, and executable computer software stored on the computer storage memory. Information specific to a participant within the marketing network and the occurrence of an event or event that result in the reward of a monetary credit to the network participant are inputted or otherwise entered into the memory of the computer. The executable computer software when executed by the computer processor is capable of associating the occurrence of an event or events with a network participant. Once the computer software has identified the relevant network participant, has received an input relating to the occurrence of an event or event, and has associated the occurrence of the event or events with the identified network participant, then the computer software calculates a monetary credit to be rewarded to the participant, based upon the occurrence of the identified and associated event or events. The computer is capable of storing the rewarded monetary credit to the identified participant in the storage memory of the computer. A monetary amount calculated by the computer software and an electronic payment is forwarded via the computer network to a third party payee on behalf of the network participant in at least partial payment of a debt of the participant.

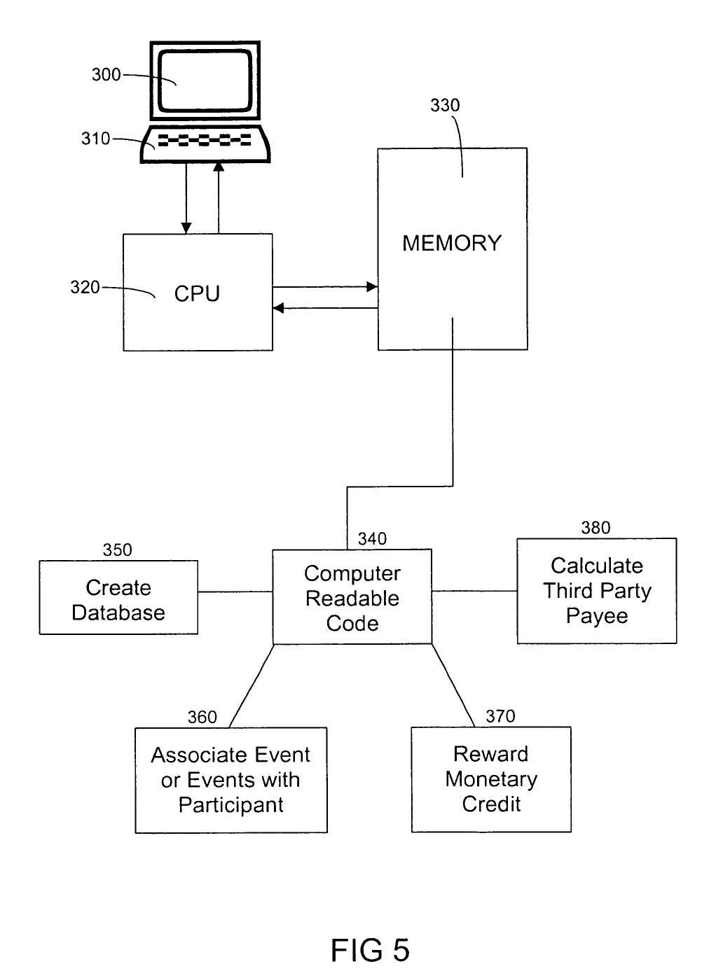

As shown in FIG. 5, a computer system 300 for use in connection with a method of compensating participants within a network is also provided. The computer system 300 comprises input receiving means, an user interface 310, a processor 320, and computer storage memory 330 comprising a computer readable storage medium having computer readable program code 340 embodied in the medium.

The central processor unit (CPU) 320 or processor may comprise one or more data processors configured in a personal computer, work station, main frame, network, or other conventional apparatus. The user interface 310 may include traditional equipment such as a monitor and printer for displaying information for the user and keyboard and mouse for inputting information into the computer system. The computer system may also include additional peripherals such as a scanner, voice recognition systems, and touch screens to facilitate use. The computer system can further be configured as a network of computers in a known manner.

Memory 330 is operatively connected to the processor 320. Memory contains program code 340 of a computer program or series of programs to instruct the computer system 300 to perform certain tasks in connection with the method of the present invention. The computer software program code 340 may be adapted to function on known operating systems or platforms, and is anticipated to be compatible with emerging operating systems as well.

Still referring to FIG. 5, the computer readable program code 340 embodied in the computer readable storage medium 330 includes computer readable code 340 for carrying out at least the following tasks

(a) creating a database of marketing network participants 350,

(b) associating the occurrence of at least one event with a marketing network participant selected from the created database 360,

(c) rewarding a monetary credit to the selected marketing network participant based on the at least one event associated with the marketing network participant 370, and

(d) calculating an amount based on at least a portion of the monetary credit rewarded to the participant 380, wherein the calculated amount is to paid to a third party payee on behalf of the participant in at least partial payment of a debt of said participant.

According to other embodiments, the computer readable code embodied on the computer readable storage medium is also for

(e) communicating with a computer network and for forwarding via the computer network an electronic payment to a third party payee on behalf of the participant in at least partial payment of a debt of the participant.

According to further embodiments, the method of compensating a participant within a marketing network and paying a third party payee comprises

(a) providing a computer in communication with a computer network, said computer comprising input receiving means, a processor, computer readable storage medium having computer readable program code embodied in said medium, said computer readable program code comprising
(1) creating a database of marketing network participants,
(2) associating the occurrence of at least one event with a marketing network participant selected from the created database,
(3) rewarding a monetary credit to be rewarded to the selected marketing network participant based on the at least one event associated with the marketing network participant, and
(4) calculating an amount based on at least a portion of the monetary credit rewarded to the participant, wherein the calculated amount is to paid to a third party payee on behalf of the participant in at least partial payment of a debt of said participant,

(b) inputting into the computer information relating to a participant within the marketing network and the occurrence of at least one event that results in the reward of a monetary credit to the participant,

(c) associating the occurrence of at least one event with a marketing network participant identified from the created database,

(d) rewarding a monetary credit to the identified marketing network participant based on the at least one event associated with the marketing network participant, and

(e) calculating an amount based on at least a portion of the monetary credit rewarded to said participant; and

(f) forwarding the calculated amount to a third party payee on behalf of the participant in at least partial payment of a debt of the participant.

A computer program product for use with a computer is also provided. The computer software program includes a computer readable storage medium having computer readable program code embodied in the readable medium, the computer readable program code for carrying out the following tasks

(a) for creating a database of marketing network participants,

(b) for associating the occurrence of at least one event with a marketing network participant selected from the created database,

(c) for rewarding a monetary credit to the selected marketing network participant based on the at least one event associated with the marketing network participant, and

(d) for calculating an amount based on at least a portion of the monetary credit rewarded to said participant, wherein the calculated amount is to paid to a third party payee on behalf of the participant in at least partial payment of a debt of said participant.

According to other embodiments, the computer readable code embodied on the computer readable storage medium is for

(e) communicating with a computer network and for forwarding via the computer network an electronic payment to a third party payee on behalf of the participant in at least partial payment of a debt of the participant.

Without limiting the present invention to any particular type of product, service, trade channel, or business, the method of marketing and compensating persons, such as participants within a marketing network, the computer software, and the computer system can be utilized in connection with the marketing and sale of products and/or services in the general field of biological sample collection and storage.

The method can be utilized in connection with compensating participants in a marketing network for the marketing and sale of collection and storage services for any type of biological sample. In one embodiment, the biological sample is a sample of human cells. The method is not intended to be limited to use in connection with the marketing and sale of any particular type of human cells, buts finds application in connection with marketing and selling collection and storage services for human stem cell samples. In this context, the human stem cells can be isolated from human umbilical cord matrix or human umbilical cord blood.

While not intending to limit the use of the method, computer software, or computer system to the marketing and sale of products and/or services in the field of biological sample collection and preservation, the method, software, and system and may by used in the context of the human stem cell collection and storage. In the human stem cell collection and storage industry, a maternity patient (i.e.—an expectant parent) is introduced to the concept of stem cell collection and storage. The expectant parent elects to participate in the process of collecting and storing the umbilical stem cells taken from the umbilical cord of the live birth. The stem cells are collected, processed, and stored in a suitable repository. The owner of the stem cell sample pays an annual fee to the stem cell banking company for continued storage and preservation of the stem cell sample. If needed, the stem cell sample can be accessed, processed, and therapeutically administered to an individual.

Again, while not intending to limit the invention to application to the general field of umbilical cord stem cell collection and storage, the invention will be further described by way of embodiments illustrated in the FIGURES.

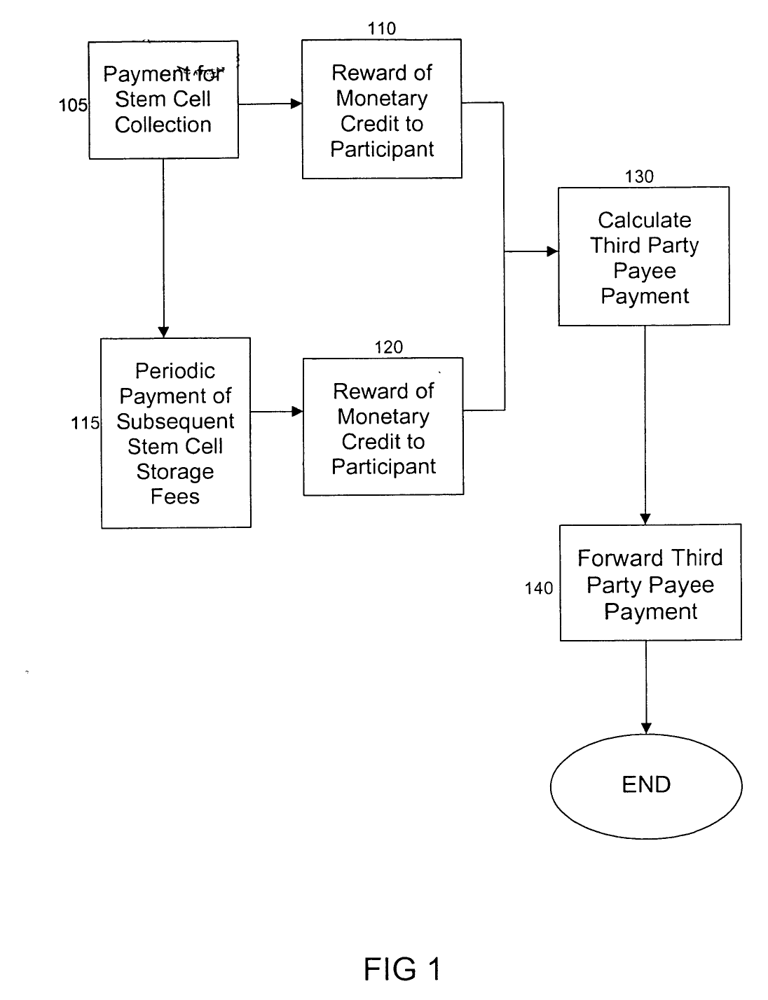

FIG. 1 is a flow chart to be used to further illustrate the one embodiment 100 of the method of the present invention. The marketing network participant introduces a maternity patient, for example, an expectant mother, to a program of collecting and storing stem cells from the live birth. The maternity patient elects to purchase a human stem cell collection and storage program from the network marketing participant. In 105, the maternity patient executes the necessary contract and pays the human stem cell collection and storage purchase fee to the marketing network participant. As shown in 110, the marketing network participant is rewarded with a monetary credit, based upon the payment by the maternity patient to the marketing network participant of the fee for the stem cell collection and storage program.

After the maternity patient has given birth to the baby, the stem cells are collected, transported to an appropriate facility, processed, and stored 130. Subsequent periodic payments 115 must be paid for the continued storage and preservation of the “banked” stem cell sample. Upon the receipt of such periodic payment 115, the marketing network participant is rewarded with a monetary credit 120. While it is customary for the periodic payments for continued storage and preservation of the stem cell samples to be made on an annual basis, it should be understood that payments can be made at various times and according to various payment schedules. However, the participant is rewarded with the monetary credit 120 upon receipt of the payment, whether or not that payment is made on annual basis or some other payment schedule.

The monetary credits 110, 120 rewarded to the network participant as a result of the payment of the initial stem cell collection program fee 105 and subsequent periodic continued storage and preservation fees 115, are combined and an amount is calculated 130. The calculated amount is then forwarded 140 to a third party payee of the of the participant in payment of a debt of the participant.

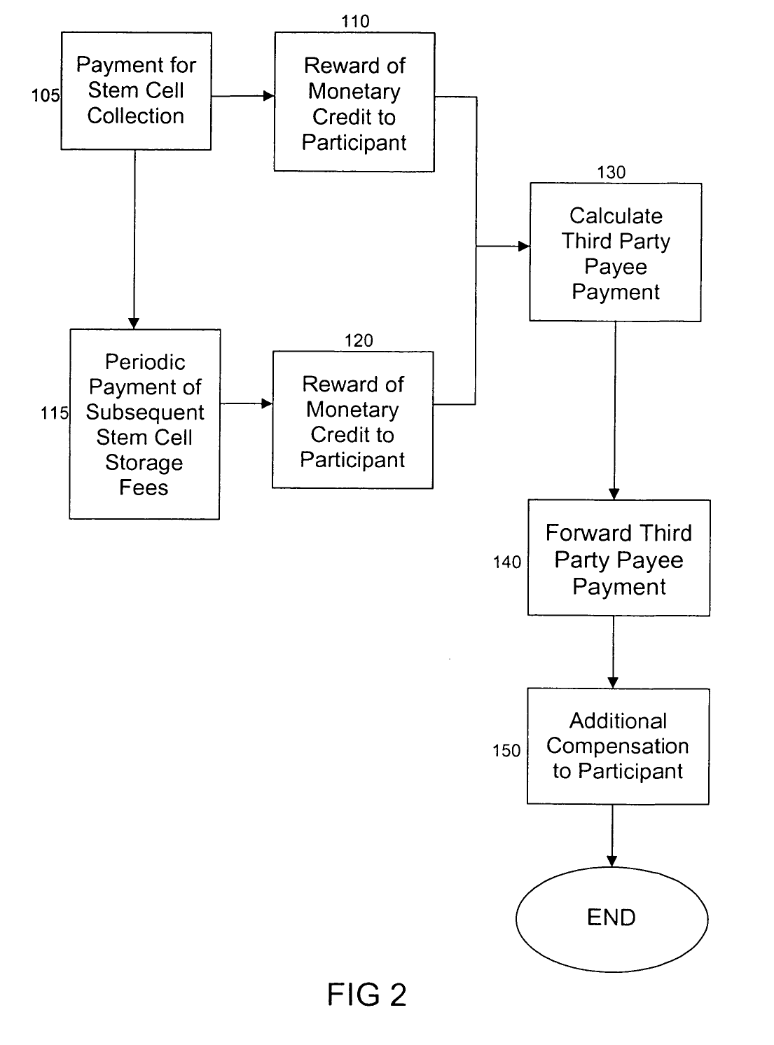

FIG. 2 is a flow chart to be used to further illustrate the another embodiment of the method of the present invention. According to this embodiment, after the debt of the participant to the third party payee has been paid in full, then the participant is directly rewarded with further compensation 150, such as, for example, in the form of a cash payment.

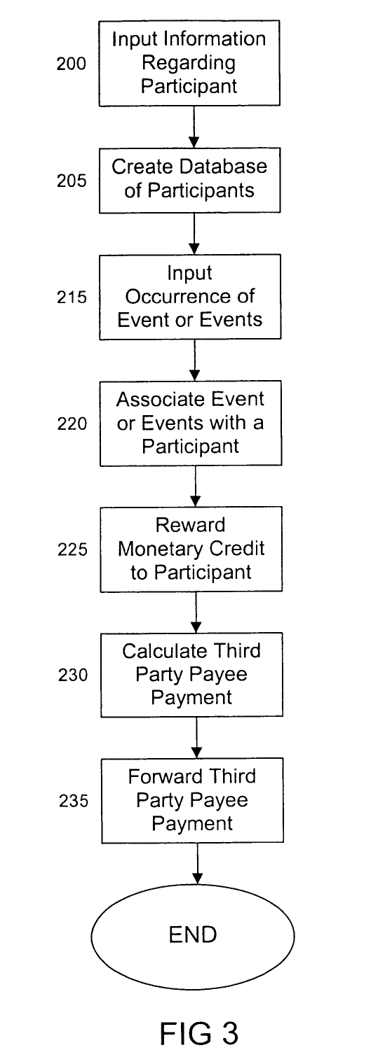

FIG. 3 is a flow diagram of the use of a computer system in connection with the method of the invention. In step 200, the computer receives an input including the information and identity of a network participant 205. The computer software creates a database 210 of marketing network participants. The computer also receives an input of the occurrence of an event or event 215 that gives rise to the reward of a monetary credit to an inputted participant. Based upon user instruction, the software selects a marketing network participant from the created database 210 of eligible participants and associates 220 the occurrence of at least one event with a marketing network participant selected from the created database. The software rewards 225 monetary credit to the marketing network participant selected from the database, based on the at least one event associated with the marketing network participant. At the appropriate time, the software calculates 230 an amount based on at least a portion of the monetary credits rewarded 225 to the participant. It is this calculated 230 amount that is to paid 235 to a third party payee on behalf of the participant in at least partial payment of a debt of the participant.

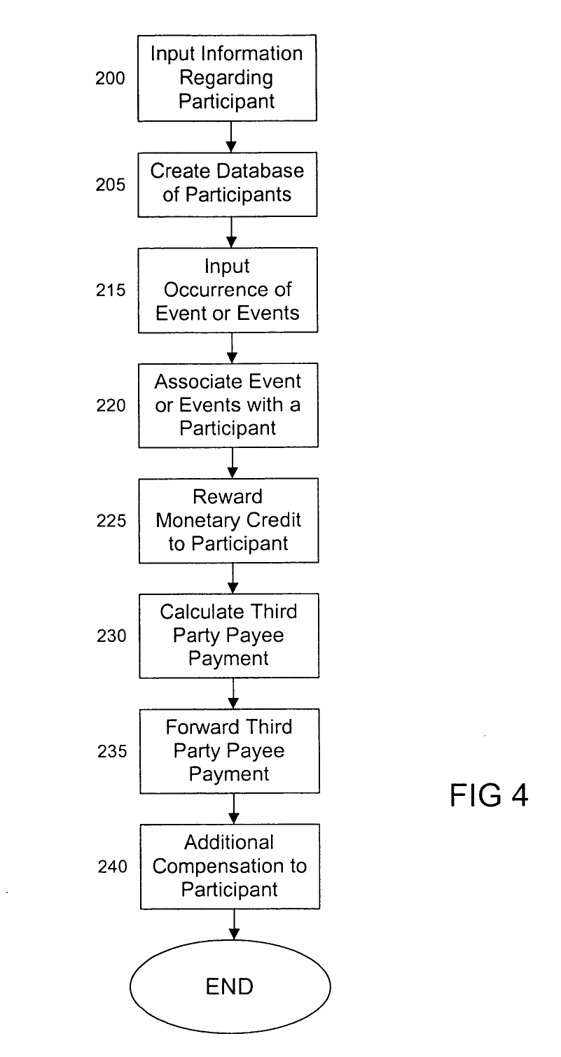

According to the embodiment shown in FIG. 4, the payment 235 to the third party payee is made by forwarding 240 via the computer network an electronic payment to a third party payee on behalf of the participant in at least partial payment of a debt of the participant.

In using the method, computer software, and computer system in the context of marketing and selling human stem cell collection and storage services, the events that give rise to, or otherwise entitle the network participant, to the reward of the monetary credit, includes the participation of additional participants within the marketing network, the initial monetary payment by a maternity patient to network participant for collection and storage of the stem cell sample, the subsequent periodic monetary payments for the continued storage and preservation of the stem cell sample. Existing network participants receive monetary credits for collection and storage service they actually sell, and for collection and storage services sold by those network participants that are assigned to their “downline.”

With respect to the event comprising the participation of additional participants within the marketing network, the computer software automatically assigns a new network participant to an existing participant's network “downline,” so that the existing network participant does not need to place emphasis on recruiting new participants into the network. Rather, the existing network participants can focus on the marketing and sale of the collection and storage services.

The sum of the cumulative monetary credits earned by a network participant is calculated and a payment amount generated by the computer software. The payment is forwarded to a third party payee of the participant. While any third party payee of the participant may receive an amount in at least partial payment of a debt of the participant, in one embodiment, the third party payee is the medical malpractice insurance carrier of the network participant and the payment is applied to the premium for medical malpractice insurance of the participant. After the medical malpractice premium is paid in full for a given coverage period, then the participant is entitled to receive additional monetary compensation, based on the occurrence of additional events.

While the present invention has been described above in connection with the preferred embodiments, it is to be understood that other similar embodiments may be used or modifications and additions may be made to the described embodiments for performing the same function of the present invention without deviating therefrom. Further, all embodiments disclosed are not necessarily in the alternative, as various embodiments of the invention may be combined to provide the desired characteristics. Variations can be made by one having ordinary skill in the art without departing from the spirit and scope of the invention. Therefore, the present invention should not be limited to any single embodiment, but rather construed in breadth and scope in accordance with the recitation of the attached claims.

I claim:

1. A method of compensating participants within a marketing network comprising:
rewarding a monetary credit to said participant based upon the occurrence of at least one event; and
forwarding a monetary payment to a third party payee on behalf of said participant in at least partial payment of a debt of said participant, wherein said monetary payment comprises a portion of said monetary credit rewarded to said participant.

2. The method of claim 1, wherein said participant is a birthing professional.

3. The method of claim 2, wherein said birthing professional is selected from the group consisting of medical doctors and midwives.

4. The method of claim 3, wherein said birthing professional is a medical doctor.

5. The method of claim 1, wherein said at least one event is participation of a new participant in the marketing network.

6. The method of claim 1, wherein said at least one event is the monetary payment by a maternity patient to said participant for collection and storage of a biological sample.

7. The method of claim 6, wherein said biological sample is a sample of human cells.

8. The method of claim 7, wherein said human cells are human stem cells.

9. The method of claim 8, wherein said human cells are human stem cells isolated from human umbilical cord matrix.

10. The method of claim 9, wherein said human stem cells are isolated from human umbilical cord blood.

11. The method of claim 8, wherein said at least one event is a periodic monetary payment for the continued storage and preservation of said stem cells.

12. The method of claim 1, wherein said at least one event comprises the monetary payment by a maternity patient for collection and storage of a biological sample and subsequent periodic payments of a monetary fee for storage and preservation of said biological sample.

13. The method of claim 1, wherein said debt is a premium payment for medical malpractice insurance of said participant.

14. The method of claim 1, further comprising providing additional monetary compensation to said participant after said debt to said third party payee has been paid in full.

15. A method of compensating participants within a marketing network comprising:
selecting a participant within said marketing network;
identifying the occurrence of at least one event which results in the reward of a monetary credit to said participant;
associating the occurrence of said at least one said event with said participant;
rewarding a monetary credit to said participant based upon the occurrence of said at least one event; and
forwarding a monetary payment to a third party payee on behalf of said participant in at least partial payment of a debt of said participant, wherein said monetary payment comprises a portion of said monetary credit rewarded to said participant.

16. The method of claim 15, wherein said participant is a birthing professional.

17. The method of claim 16, wherein said birthing professional is selected from the group consisting of medical doctors and midwives.

18. The method of claim 17, wherein said birthing professional is a medical doctor.

19. The method of claim 15, wherein said at least one event is participation of a new participant in the marketing network.

20. The method of claim 15, wherein said at least one event is the monetary payment by a maternity patient to said participant for collection and storage of a biological sample.

21. The method of claim 20, wherein said biological sample is a sample of human cells.

22. The method of claim 21, wherein said human cells are human stem cells.

23. The method of claim 22, wherein said human cells are human stem cells isolated from human umbilical cord matrix.

24. The method of claim 23, wherein said human stem cells are isolated from human umbilical cord blood.

25. The method of claim 22, wherein said at least one event is a periodic monetary payment for the continued storage and preservation of said stem cells.

26. The method of claim 15, wherein said at least one event comprises the monetary payment by a maternity patient for collection and storage of a biological sample and subsequent periodic payments of a monetary fee for storage and preservation of said biological sample.

27. The method of claim 15, wherein said debt is a premium payment for medical malpractice insurance of said participant.

28. The method of claim 15, further comprising providing additional monetary compensation to said participant after said debt to said third party payee has been paid in full.

29. A method of using a computer to compensate participants within a marketing network comprising:
inputting into a computer information relating to a participant within said marketing network and the occurrence of at least one event that gives rise to the reward of a monetary credit to said participant;
processing said information thereby associating the occurrence of said at least one event with said participant and rewarding a monetary credit to said participant; and
forwarding a monetary payment to a third party payee on behalf of said participant in at least partial payment of a debt of said participant, wherein said monetary payment comprises a portion of said monetary credit rewarded to said participant.

30. The method of claim 29, wherein said participant is a birthing professional.

31. The method of claim 30, wherein said birthing professional is selected from the group consisting of medical doctors and midwives.

32. The method of claim 31, wherein said birthing professional is a medical doctor.

33. The method of claim 29, wherein said at least one event is participation of a new participant in the marketing network.

34. The method of claim 29, wherein said at least one event is the monetary payment by a maternity patient to said participant for collection and storage of a biological sample.

35. The method of claim 34, wherein said biological sample is a sample of human cells.

36. The method of claim 35, wherein said human cells are human stem cells.

37. The method of claim 36, wherein said human cells are human stem cells isolated from human umbilical cord matrix.

38. The method of claim 37, wherein said human stem cells are isolated from human umbilical cord blood.

39. The method of claim 36, wherein said at least one event is a periodic monetary payment for the continued storage and preservation of said stem cells.

40. The method of claim 29, wherein said at least one event comprises the monetary payment by a maternity patient for collection and storage of a biological sample and subsequent periodic payments of a monetary fee for storage and preservation of said biological sample.

41. The method of claim 29, wherein said debt is a premium payment for medical malpractice insurance of said participant.

42. The method of claim 29, further comprising providing additional monetary compensation to said participant after said debt to said third party payee has been paid in full.

43. The method of claim 29, wherein said computer comprises input receiving means, a processor, computer storage memory, and executable computer software stored on said computer storage memory.

44. A method of using computer to compensate participants within a marketing network comprising:
inputting into said computer information relating to a participant within said marketing network and the occurrence of at least event that gives rise to the reward of a monetary credit to said participant, said computer comprising input receiving means, a processor, computer storage memory, and executable computer software stored on said memory;
said computer software associating the occurrence of at least one said event with said participant;
said computer software calculating a monetary credit to be rewarded to said participant based upon the occurrence of said at least one event associated with said participant;
said computer software rewarding said monetary credit to said participant;
storing said rewarded monetary credit to said participant in said computer storage memory;
said computer software calculating an amount based on at least a portion of said monetary credit rewarded to said participant; and
forwarding said amount to a third party payee on behalf of said participant in at least partial payment of a debt of said participant.

45. The method of claim 44, wherein said participant is a birthing professional.

46. The method of claim 45, wherein said birthing professional is selected from the group consisting of medical doctors and midwives.

47. The method of claim 46, wherein said birthing professional is a medical doctor.

48. The method of claim 44, wherein said at least one event is participation of a new participant in the marketing network.

49. The method of claim 44, wherein said at least one event is the monetary payment by a maternity patient to said participant for collection and storage of a biological sample.

50. The method of claim 49, wherein said biological sample is a sample of human cells.

51. The method of claim 50, wherein said human cells are human stem cells.

52. The method of claim 51, wherein said human cells are human stem cells isolated from human umbilical cord matrix.

53. The method of claim 52, wherein said human stem cells are isolated from human umbilical cord blood.

54. The method of claim 51, wherein said at least one event is a periodic monetary payment for the continued storage and preservation of said stem cells.

55. The method of claim 44, wherein said at least one event comprises the monetary payment by a maternity patient for collection and storage of a biological sample and subsequent periodic payments of a monetary fee for storage and preservation of said biological sample.

56. The method of claim 44, wherein said debt is a premium payment for medical malpractice insurance of said participant.

57. The method of claim 44, further comprising providing additional monetary compensation to said participant after said debt to said third party payee has been paid in full.

58. A method of compensating a participant within a marketing network and paying a third party payee comprising:
providing a computer in communication with a computer network, said computer comprising input receiving means, a processor, computer storage memory, and executable computer software stored on said computer storage memory;
inputting into said computer information relating to a participant within said marketing network and the occurrence of at least event that gives rise to the reward of a monetary credit to said participant;
said computer software associating the occurrence of at least one said event with said participant;
said computer software calculating a monetary credit to be rewarded to said participant based upon the occurrence of said at least one event associated with said participant;
said computer software rewarding said monetary credit to said participant;
storing said rewarded monetary credit to said participant in said computer storage memory;
said computer software calculating an amount based on at least a portion of said monetary credit rewarded to said participant; and
forwarding via said computer network an electronic payment in said calculated amount to a third party payee on behalf of said participant in at least partial payment of a debt of said participant.

59. The method of claim 58, wherein said participant is a birthing professional.

60. The method of claim 59, wherein said birthing professional is selected from the group consisting of medical doctors and midwives.

61. The method of claim 60, wherein said birthing professional is a medical doctor.

62. The method of claim 58, wherein said at least one event is particpation of a new participant in the marketing network.

63. The method of claim 58, wherein said at least one event is the monetary payment by a maternity patient to said participant for collection and storage of a biological sample.

64. The method of claim 63, wherein said biological sample is a sample of human cells.

65. The method of claim 64, wherein said human cells are human stem cells.

66. The method of claim 65, wherein said human cells are human stem cells isolated from human umbilical cord matrix.

67. The method of claim 66, wherein said human stem cells are isolated from human umbilical cord blood.

68. The method of claim 65, wherein said at least one event is a periodic monetary payment for the continued storage and preservation of said stem cells.

69. The method of claim 58, wherein said at least one event comprises the monetary payment by a maternity patient for collection and storage of a biological sample and subsequent periodic payments of a monetary fee for storage and preservation of said biological sample.

70. The method of claim 58, wherein said debt is a premium payment for medical malpractice insurance of said participant.

71. The method of claim 58, further comprising providing additional monetary compensation to said participant after said debt to said third party payee has been paid in full.

72. A method of compensating a participant within a marketing network and paying a third party payee comprising:
providing a computer, said computer comprising input receiving means, a processor, computer readable storage medium having computer readable program code embodied in said medium, said computer readable program code comprising:
computer readable code for creating a database of marketing network participants;
computer readable code for associating the occurrence of at least one event with a marketing network participant selected from said created database;
computer readable code for rewarding a monetary credit to said selected marketing network participant based on said at least one event associated with said marketing network participant; and
computer readable code for calculating an amount to be paid to a third party payee on behalf of said participant in at least partial payment of a debt of said participant; and
inputting into said computer information relating to a participant within said marketing network and the occurrence of at least event that results in the reward of a monetary credit to said participant;
associating the occurrence of at least one event with a marketing network participant selected from said created database;
rewarding a monetary credit to said selected marketing network participant based on said at least one event associated with said marketing network participant; and
calculating an amount based on at least a portion of said monetary credit rewarded to said participant; and
forwarding said calculated amount to a third party payee on behalf of said participant in at least partial payment of a debt of said participant.

73. A computer program product for use with a computer, said computer program comprising:
a computer readable storage medium having computer readable program code embodied in said medium, said computer readable program code comprising:
computer readable code for creating a database of marketing network participants;
computer readable code for associating the occurrence of at least one event with a marketing network participant selected from said created database;
computer readable code for rewarding a monetary credit to said selected marketing network participant based on said at least one event associated with said marketing network participant; and
computer readable code for calculating an amount based on at least a portion of said monetary credit rewarded to said participant, wherein said calculated amount is to paid to a third party payee on behalf of said participant in at least partial payment of a debt of said participant.

74. The computer program product of claim 74, comprising computer readable code for communicating with a computer network and for forwarding via said computer network an electronic payment in said calculated amount to a third party payee on behalf of said participant in at least partial payment of a debt of said participant.

75. A computer system for use in connection with a method of compensating participants within a network, said computer comprising input receiving means, a processor, computer readable storage medium having computer readable program code embodied in said medium, said computer readable program code comprising:
computer readable code for creating a database of marketing network participants;
computer readable code for associating the occurrence of at least one event with a marketing network participant selected from said created database;
computer readable code for rewarding a monetary credit to said selected marketing network participant based on said at least one event associated with said marketing network participant; and
computer readable code for calculating an amount based on at least a portion of said monetary credit rewarded to said participant, wherein said calculated amount is to paid to a third party payee on behalf of said participant in at least partial payment of a debt of said participant.

76. A method of compensating a purchaser of a biological sample collection and storage program requiring future periodic payments to maintain the program in force, the method comprising:
providing to said purchaser, at the time of the purchase of said program, a voucher that is redeemable at a future time for a monetary sum; and
after said voucher is redeemed, applying said monetary sum to at least one future periodic program payment.

77. The method of claim 76, wherein said biological sample is a sample of human cells.

78. The method of claim 77, wherein said human cells are human stem cells isolated from human umbilical cord matrix.

79. The method of claim 77, wherein said human cells are human stem cells isolated from human umbilical cord blood.

80. A method of compensating a third party designee of a purchaser of a biological sample collection and storage program comprising:
providing to said purchaser, at the time of the purchase of said program, with a voucher that is redeemable at a future time for a monetary sum by a third party designee of said purchaser.

81. The method of claim 80, wherein said biological sample is a sample of human cells.

82. The method of claim 81, wherein said human cells are human stem cells isolated from human umbilical cord matrix.

83. The method of claim 81, wherein said human cells are human stem cells isolated from human umbilical cord blood.
